(19) United States
(12) Patent Application Publication
(10) Pub. No.: US 2008/0315467 A1
(43) Pub. Date: Dec. 25, 2008

(54) Method of manufacturing a plastic sleeve

(75) Inventor: Michael von Wilcke, Birkenwerder (DE)

Correspondence Address: Friedrich Kueffner;Suite 910, 317 Madison Avenue, New York, NY, 10017, US

(73) Assignee: Hafele Berlin GmbH & Co. KG

(21) Appl. No.: 11/820,886

(22) Filed: Jun. 21, 2007

(51) Int. Cl. B29D 22/00

(52) U.S. Cl. 264/573

(57) ABSTRACT

A method of manufacturing a plastic sleeve, particularly an expanding sleeve, includes injection molding the plastic sleeve with an inserted core in an injection molding tool, subsequently pulling the core and inserting the metal pin without heads, cones or the like into the bore of the plastic sleeve placed in the injection molding tool, and subsequently injection molding in the same injection molding tool the heads, cones or the like on both ends of the metal pin, and subsequently injecting the plastic sleeve with inserted metal pin from the tool.

### BACKGROUND OF THE INVENTION

1. Field of the Invention

The present invention relates to a method of manufacturing a plastic sleeve.

2. Description of the Related Art

Plastic sleeves which have an inserted metal pin provided on both sides with heads, cones or the like, are conventionally manufactured in separate injection molding processes, wherein the plastic sleeve is composed of two halves which are hinged together and can be locked together. The metal pins are provided with the heads or cones or the like in a separate injection molding process. Subsequently, the metal pins are placed in one half of the plastic sleeve, the two halves then are pivoted together and are locked together. A disadvantage of this process is the fact that the plastic sleeves and the heads or cones at the pins must be injection molded separately and are only then brought together. Subsequently, the pins must be placed in the plastic sleeves and the sleeves must be closed as described above.

### SUMMARY OF THE INVENTION

Since such plastic sleeves are manufactured in large numbers, it is the primary object of the present invention to fundamentally simplify the manufacturing process.

For this purpose, in accordance with the present invention, the plastic sleeve is injection molded with the core being in place in an injection molding tool, the core is subsequently pulled and the metal pin is pushed without heads, cones or the like into the bore of the plastic sleeve which is in the injection molding tool and, subsequently, in the same injection molding tool, the heads, cones or the like are injection molded onto the metal pin and the plastic sleeve is then injected from the tool with the metal pin placed in the plastic sleeve.

The method according to the present invention provides significant advantages in the manufacture of the plastic sleeve, because the plastic sleeve as well as the metal pin can be manufactured in an injection molding tool and after the injection molding process no additional work procedures are required, for example, a folding together of the plastic sleeve.

In accordance with another feature of the invention, the heads, the cones or the like are injection molded from a plastic material which has different properties as the plastic material of the plastic sleeve. In particular, the plastic sleeve is of a plastic material having a higher melting point than the plastic material used for the heads and the cones. In this manner, it is possible to prevent that the plastic material of the heads and cones from being mixed with the plastic material of the plastic sleeve when the heads and cones are injection molded. This is of particular importance when, in accordance with another feature of the invention, in a plastic sleeve constructed as an expanding sleeve, a cone is injection molded onto one end of the metal pin in the expanding part which is partially provided with openings. This is because, after processing the pins, the plastic material required for the cone is injection molded through the openings of the expanding part, wherein the two plastic materials could be mixed. This can be prevented by this feature of the invention.

It is possible to injection mold the head and the cone simultaneously or to injection mold the cone and then the head, or vice versa.

In accordance with an advantageous feature, the metal pin is provided in the conventional manner prior to the insertion into the bore of the plastic sleeve with undercuts at both ends, so that the head and the cone are better secured on the metal pin.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a an elevational view of an expanding sleeve of plastic material after the injection molding process without core;

FIG. 2 is a view of the sleeve of FIG. 1 with a metal pin in position for insertion;

FIG. 3 is a cross-sectional view of the expanding sleeve of FIG. 1 shown with an inserted metal pin and an injection molded cone and head on the pin; and

FIG. 4 is an elevational view of the expanding sleeve of FIG. 3.

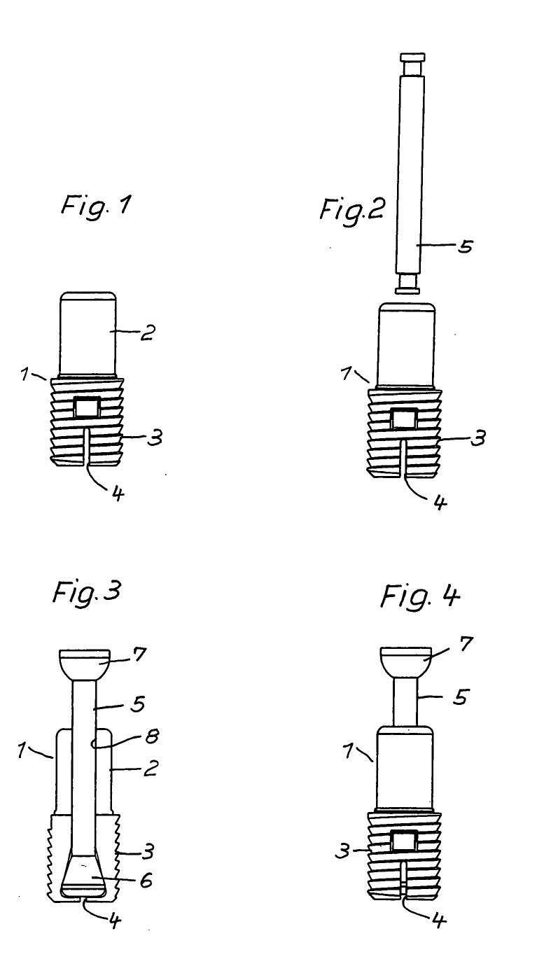

### DETAILED DESCRIPTION OF THE INVENTION

A plastic sleeve 1 composed of plastic material has a front guide part 2 and a rear expanding part 3 with slots 4 for expansion. The metal pin 5 is inserted into the bore 8 of the expanding sleeve 1 up to a point closely adjacent the end of the expanding part 3, as illustrated in FIG. 3. Subsequently, in a process not illustrated in the drawing, the cone 6 is injection molded onto the metal pin 5 through the slots 4 of the expanding part 3 and the head 7 is injection molded onto the other free end.

While specific embodiments of the invention have been shown and described in detail to illustrate the inventive principles, it will be understood that the invention may be embodied otherwise without departing from such principles.

I claim:

1. A method of manufacturing a plastic sleeve, particularly an expanding sleeve, in an injection molding tool, wherein a metal pin is inserted in a bore of the sleeve, and wherein the metal pin is provided on both ends thereof with heads, cones or the like composed of plastic material, the method comprising injection molding the plastic sleeve with an inserted core in an injection molding tool, subsequently pulling the core and inserting the metal pin without heads, cones or the like into the bore of the plastic sleeve placed in the injection molding tool, subsequently injection molding in the same injection molding tool the heads, cones or the like on both ends of the metal pin, and subsequently ejecting the plastic mold with inserted metal pin from the tool.

2. The method according to claim 1, wherein the heads, cones or the like are of a plastic material having different properties than the plastic material of the plastic sleeve.

3. The method according to claim 2, wherein the plastic sleeve is of a plastic material having a higher melting point than the plastic material used for the heads, cones or the like.

4. The method according to claim 1, wherein, in a plastic sleeve constructed as an expanding sleeve, a cone is injection molded on one side of the metal pin within the expanding part provided partially with openings, and injection molding a head on another side of the pin outside of the plastic sleeve.

5. The method according to claim 4, wherein the head and cone are injection molded onto the pin simultaneously.

6. The method according to claim 4, wherein the cone is injection molded onto the pin first and the head is injection molded onto the pin subsequently.

7. The method according to claim 4, wherein the head is injection molded onto the pin first and the cone is injection molded onto the pin subsequently.

8. The method according to claim 1, further comprising providing the metal pin prior to insertion into the bore of the plastic sleeve with undercuts at both ends thereof.
